(19) United States
(12) Patent Application Publication
(10) Pub. No.: US 2015/0006584 A1
(43) Pub. Date: Jan. 1, 2015

(54) MANAGING A COMPLEX OBJECT IN A CLOUD ENVIRONMENT

(71) Applicant: INTERNATIONAL BUSINESS MACHINES CORPORATION, Armonk, NY (US)

(72) Inventors: LI-JU CHEN, TAIPEI (TW); YING C. GUO, BEIJING (CN); XIN S. MAO, BEIJING (CN); BO YANG, BEIJING (CN); HUA ZHANG, BEIJING (CN)

(73) Assignee: INTERNATIONAL BUSINESS MACHINES CORPORATION, Armonk, NY (US)

(21) Appl. No.: 14/294,908

(22) Filed: Jun. 3, 2014

(30) Foreign Application Priority Data
Jun. 27, 2013 (CN) 201310261714.3

(51) Int. Cl. G06F 17/30

(52) U.S. Cl. CPC G06F 17/30604; G06F 17/30607
USPC 707/792

(57) ABSTRACT

The present invention discloses a method of managing a complex object in a cloud environment and a system thereof. In the method, an object model of the complex object is obtained, the object model comprises at least information describing a constraint, an attribute and a method of the complex objects. Then, the object model is analyzed to determine at least one desired data storage mapped with the object model and at least one desired data service representing an object service interface for accessing the complex object. Then, at least one data storage and at least one data service for the complex object are generated in the cloud environment based on the desired at least one data storage and at least one data service.

### BACKGROUND

The present invention relates to System of Engagement applications, and more specifically, to a method and system for managing a complex object for the System of Engagement applications in a cloud environment.

In System of Engagement applications such as a MicroBlogger system, Mobile Banking, the object such as person, weibo, comment is complex. For example, data format of the object are varied, including structural data/un-structure data, plain text data/multimedia data. Further, there is a certain relationship between the objects. For example, the object ‘person’ can have the object ‘microblogger’, and the object ‘microblogger’ can have the object ‘comment’. In addition, the data structure of the object might be changed with the development of the System of Engagement applications, and the object data is exploding.

Now the object in the System of Engagement application is explained by way of an example. For instance, in such the System of Engagement application as Mobile Banking, the person ‘John’ and the fund ‘New Energy’ are the objects. The person ‘John’ is a VIP customer and follows the fund ‘New Energy’. A rule is set for the fund ‘New Energy’, i.e. if ROI (Return On Investment) is more than 25%, notify the VIP customer who follows this fund. Thus, there is the ‘follow’ relationship between the person ‘John’ and the fund ‘new energy’, and the person ‘John’ will get a notification when the ROI of the fund ‘new energy’ is above 25%.

Due to the above features of the objects in the System of Engagement applications, how to declare, manage and consume such objects in the cloud environment are challenges.

In the prior art, the objects are usually defined by programmers when writing a program for the System of Engagement application, and if the program of the System of Engagement application is to be running in the cloud environment, there is also a need to provision Virtual Machines (VMs) with data storages manually. Specifically, first, data structures of the objects will be defined, and the data related to the objects are mapped to different kinds of data storages, then the program is written to store and fetch the data. It can be seen that since the objects are defined in the program in advance and mappings from the object data to the data storages are generated, if the data structures of the objects have been changed, the program of the System of Engagement application needs to be modified. Such the method of defining and managing objects is very inflexible.

Additionally, there is also provided a method of providing a simple interface based on an existing platform to manage the objects of the System of Engagement application, which can manage the objects by providing the user with a graphic user interface. The graphic user interface can be used by the user to define the objects and actions. However, the interface must be based on the existing platform for System of Engagement applications, and can only provide the limited capability.

### SUMMARY

According to one aspect of the present invention, there is provided a method for managing a complex object in a cloud environment, which comprises: obtaining, by one or more processors, an object model of the complex object, the object model comprising at least information describing a constraint, an attribute and a method of the complex object; analyzing, by one or more processors, the object model to obtain at least one data storage mapped with the object model and at least one data service representing an object service interface for accessing the complex object; and generating, by one or more processors, at least one data storage and at least one data service for the complex object in the cloud environment based on the mapped at least one data storage and the obtained at least one data service.

According to another aspect of the present invention, there is provided a system for managing a complex object in a cloud environment, which comprises: obtaining hardware apparatus configured to obtain an object model of the complex object, the object model comprising at least information describing a constraint, an attribute and a method of the complex object; analyzing hardware apparatus configured to analyze the object model to obtain at least one data storage mapped with the object model and at least one data service representing an object service interface for accessing the complex object; and generating hardware apparatus configured to generate at least one data storage and at least one data service for the complex object in the cloud environment based on the mapped at least one data storage and the obtained at least one data service.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 is a schematic flowchart of the method for managing a complex object in a cloud environment according to an embodiment of the present invention;

FIG. 5 shows an exemplary diagram of the complex object according to embodiments of the present invention;

FIG. 6 is a schematic flowchart of the step of analyzing the object model of the complex object in the method shown in FIG. 4;

FIG. 7 is a schematic flowchart of the step of generating the data storage and data service in the method shown in FIG. 4;

FIG. 8 is a diagram of the VM structure for the data storages and data services of the complex object generated by the method of the embodiments of the invention;

FIG. 9 is a schematic flowchart of the method for managing a complex object in a cloud environment according to another embodiment of the present invention;

FIG. 10 is a schematic block diagram of the system for managing a complex object in a cloud environment according to an embodiment of the present invention; and

FIG. 11 is a schematic block diagram of the system of managing a complex object in a cloud environment according to another embodiment of the present invention.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

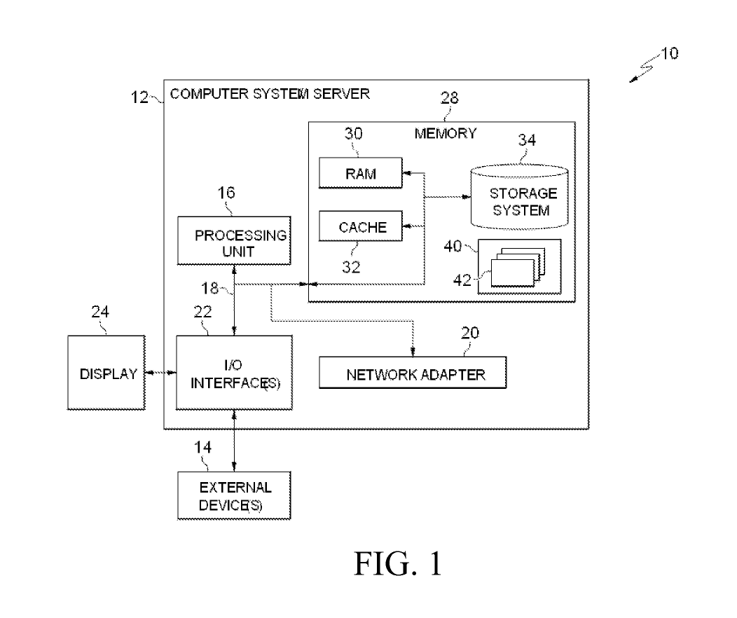

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

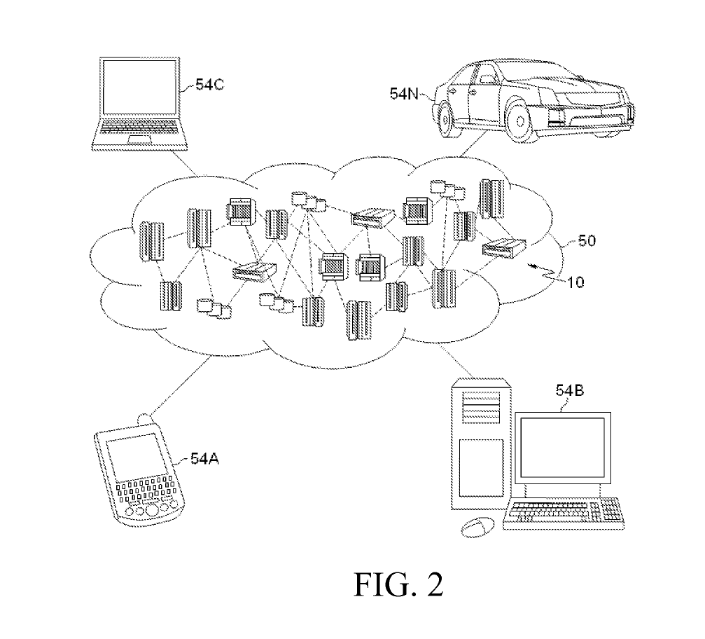

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

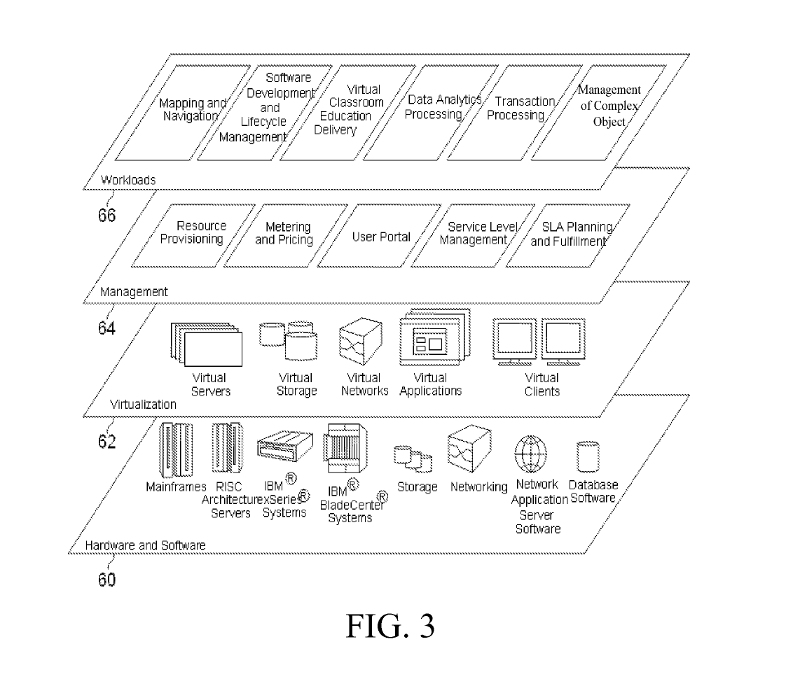

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2®, database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and management of a complex object according to the embodiments of the invention.

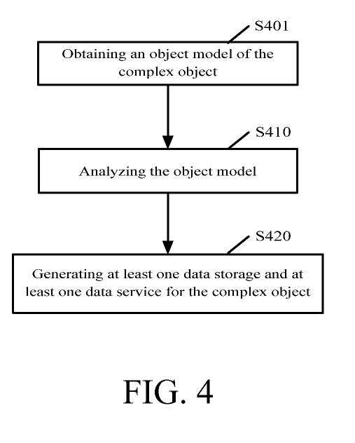

FIG. 4 shows a schematic flowchart of the method for managing a complex object in a cloud environment according to an embodiment of the present invention. The present embodiment will be described in detail below in conjunction with accompany drawings.

In the following embodiments, ‘a complex object’ is used to represent an object describing an entity in the System of Engagement application. When describing the complex object, in addition to using the traditional attributes and methods, a constraint(s) can be used. Here, the constraint means a restriction or decoration to the attribute, method of the complex object or to the complex object itself. Furthermore, when describing the complex object, a relationship and/or condition-action can also be zero, one or more, wherein the relationship describes a relation of the complex object to other complex objects, and the condition-action describes an operation of the complex object under a certain condition. In the System of Engagement application, the complex object could be continuous evolving, with growing data and varying structure.

As shown in FIG. 4, at step S401, an object model of the complex object for the System of Engagement application will be obtained. The object model of the complex object may comprise information which describes the constraint, attribute and method of the complex object. Alternatively, the object model may also comprise information which describes at least one of the relationship and the condition-action of the complex object.

In the present embodiment, the complex object may be described using a declarative programming language, e.g. an object oriented language with annotations, so as to establish the object model of the complex object. For example, the complex object may be described with ‘class’s, the attribute and method of the complex object may be described with ‘attribute’ and ‘method’, and the constraint, relationship, and condition-action of the complex object may be described with ‘annotation’.

The attribute of the complex object is used to describe nature of the complex object, which may use a simple type of data such as Int data, String data, Char data, date/time, Float data, Reference data, or use a complex type of data such as XML (eXtensible Markup Language), JSON (JavaScriptObjectNotation, a light-weighted data exchange format), video/audio, image, or use a composite type of data such as spatial data, list, table, structure.

The method of the complex object is used to describe behavior of the complex object, which may be description of any programmatic logic. In the model of the complex object, the method must be provided to manipulate the attribute of the complex type of data or the composite type of data.

The constraint of the complex object is used to describe the restriction or decoration to the attribute, method of the complex object or to the complex object itself. The constraint may comprise search-able of the attribute of the complex object, follow-able of the complex object, tag-able of the complex object, comment-able of the complex object, and locatable of the complex object.

If a certain attribute of the complex object has the constraint of search-able, it indicates that the complex object may be searched based on this attribute. In this case, this attribute will be indexed.

If the complex object has the constraint of follow-able, it indicates that the complex object may be followed by other objects, and has the relationship with the objects which are followers. In this case, the complex object may have the specific attribute to store a list of the followers, and may have the method to access and/or notify the followers.

If the complex object has the constraint of tag-able, it indicates that the complex object may be tagged with a label. In this case, the complex object may have the attribute and method to handle the label (such as add or delete the label), and have the methods to be added, accessed and searched by the label.

If the complex object has the constraint of comment-able, it indicates that the complex object may be commented. In this case, the complex object may have the method and/or attribute to deal with the comment (for example, add or delete a piece of comment).

If the complex object has the constraint of locatable, it indicates that the complex object may be located. In this case, the complex object may have the attribute to store the location, and may have the method to access the location.

The relationship of the complex object may be used to describe the relation with other objects, which may be described by the attribute using the reference type of data.

The condition-action of the complex object is used to describe the operation of the complex object under a certain condition, which may be described in a format such as ‘if <condition>, then <action>’, wherein ‘<condition>’ may be a Boolean expression, and ‘<action>’ may be a script or a method invocation of the complex object.

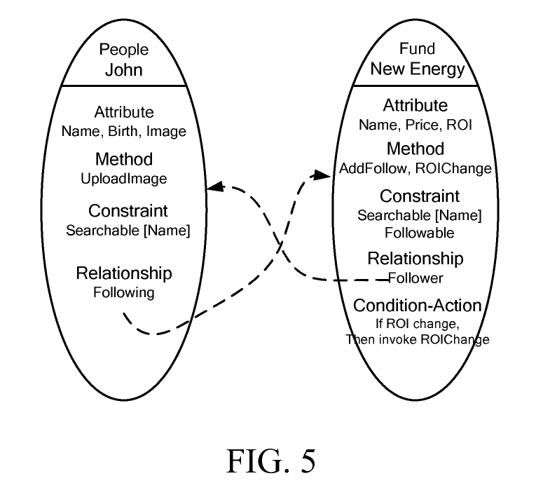

FIG. 5 shows an exemplary diagram of the complex object according to the embodiments of the present invention. In the example of Mobile Banking, there are two complex objects ‘People John’ and ‘Fund New Energy’. As shown in FIG. 5, the complex object ‘People John’ has Attribute ‘Name’, ‘Birth’ and ‘Image’, Method ‘UploadImage’, Constraint ‘Searchable [Name]’ and Relationship ‘Following Fund New Energy’. The complex object ‘Fund New Energy’ has Attribute ‘Name’, ‘Price’ and ‘ROI’, Method ‘AddFollow’, ‘ROIChange’, Constraint ‘Searchable [Name] ’, ‘Followable’, Relationship ‘Follower: People John’, and Condition-Action ‘If ROI change, then invoke method ‘ROIChange’’.

As stated above, the object model of the complex object may be established using the declarative language. Shown below is exemplary software programming code for defining the above complex object ‘Fund’. In this example, ‘name’ that uses String data, ‘ROI’ that uses Double data, ‘description’ that uses Text, ‘followers’ recording other complex objects who have followed the complex object ‘Fund’, and ‘briefing’ that uses the video data are defined in Attributes, ‘search-able’, ‘tag-able’, ‘comment-able’ and ‘follow-able’ for Attributes ‘name’ and ‘description’ are defined in Constraints, and in addition, ‘if ROI >25% AND User in followers AND User class is VIP, then notify User’ is defined in the condition-action.

```
Model DO FundDO({
  //Attributes
  name: String,
    ROI: Double,
    description: Text,
    briefing: Video,
    followers: UserDO[ ],
    locations: LocationDO,
    //Constraints: social, location, transaction
    _search-able: [name, description],
    _tag-able: yes,
    _comment-able: yes,
    _follow-able: yes,
    //Events, conditions and actions
    notifyROIChange: ECA({
      event: ROIChanged,
        condition: “if ROI>25% AND User in followers
                AND User.class==’VIP’”,
  action: User.notify(ROI),
})
```

Thus, the object models of the complex objects ‘People John’ and ‘Fund New Energy’ can describe that people (user) John may log into a portal Web page of the mobile bank, browse the funds and follow the fund New Energy. When ROI of the fund New Energy is above 25%, people John will receive a notification.

Returning to FIG. 4, after obtaining the object model of the complex object, at step S410, the object model obtained in step S401 is analyzed to determine at least one desired data storage mapped with the object model and at least one desired data service representing an object service interface for accessing the complex object.

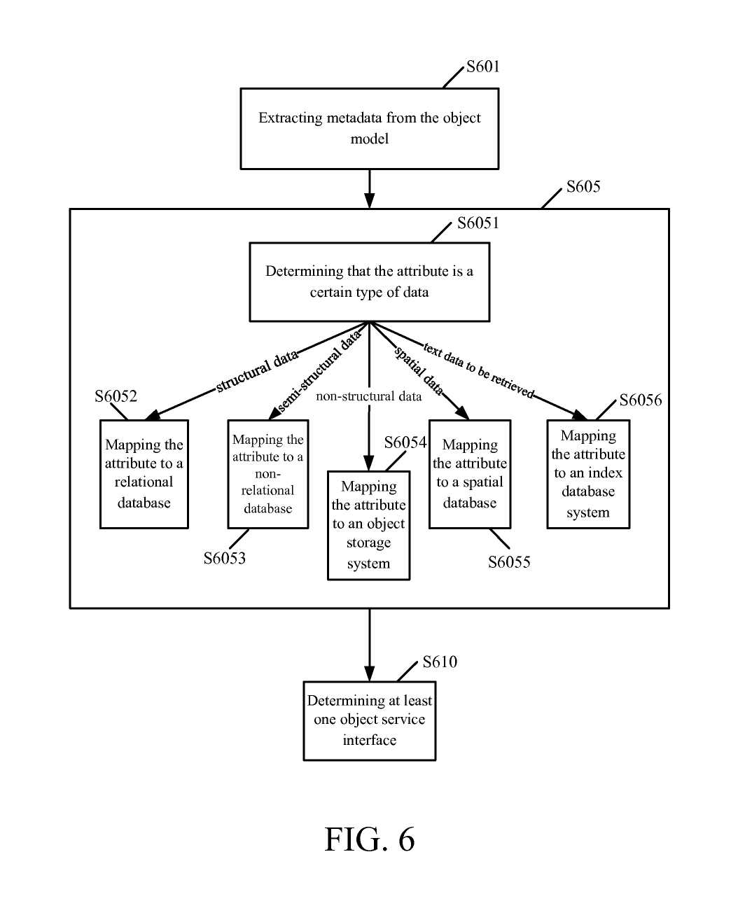

FIG. 6 shows the schematic flowchart of the analyzing step S410. As shown in FIG. 6, at step S601, metadata is extracted from the object model, the metadata is the data describing the structure of the object model. Thus, the name and data type of the attribute and the constraint in the object model may be obtained as the metadata.

Next, at step S605, the mapping from the attribute of the object model to the corresponding data storage can be established based on the extracted metadata. By means of the mapping, the data storage to be used for the complex object may be determined.

In this mapping step, firstly, at step S6051, it is determined that the attribute is any one of structural data, semi-structural data, non-structural data, spatial data and text data to be retrieved, based on the extracted metadata. As stated above, the metadata contains the data type of the attribute, so it may be determined, based on the data type, that the attribute is which one of the structural data, semi-structural data, non-structural data, spatial data and text data to be retrieved. For example, Int data, Float data, Double data, Reference data, etc. belong to the structural data, XML data, HTML document, etc. belong to the semi-structural data, and text data, audio data, video data, image data, etc. belong to the non-structural data. In addition, when the complex object has the constraint of ‘locatable’, the corresponding attribute regarding location is the spatial data. When a certain attribute of the complex object has the constraint of ‘search-able’, this attribute is the text data to be retrieved.

Then, when it is determined that the attribute is the structural data, at step S6052, the attribute is mapped to a relational database in response to determining the attribute as the structural data. Therefore, the relational database such as RDBMS database becomes one of data storages for the complex object.

When it is determined that the attribute is the semi-structural data, at step S6053, the attribute is mapped to a non-relational database in response to determining the attribute as the semi-structural data. Therefore, the non-relational database such as NoSQL database becomes one of data storages for the complex object.

When it is determined that the attribute is the non-structural data, at step S6054, the attribute is mapped to an object storage system in response to determining the attribute as the non-structural data. Therefore, the object storage system becomes one of data storages for the complex objects.

When it is determined that the attribute is the spatial data, at step S6055, the attribute is mapped to a spatial database in response to determining the attribute as the spatial data. Therefore, the spatial database becomes one of data storages for the complex object.

When it is determined that the attribute is the text data to be retrieved, at step S6056, the attribute is mapped to an index database system in response to determining the attribute as the text data to be retrieved. Therefore, the index database system becomes one of data storages for the complex object.

Then, at step S610, at least one object service interface is determined as the data service of the complex object, based on the information in the object model. In one embodiment, in response to the information which describes the attribute of the complex object, an interface for adding, deleting, modifying and querying the attribute is determined. Next, in response to the information which describes the method of the complex object, an interface for exposing a public method is determined. Then, in response to the information which describes the constraint of the complex object, an interface for adding, obtaining and deleting the constraint is determined. For example, for the constraint of ‘comment-able’, the interface function such as addComment( ), getComments( ) deleteComment( ) may be determined, and for the constraint of ‘tag-able’, the interface function such as addTag( ), getTag( ), deleteTag( ) may be determined.

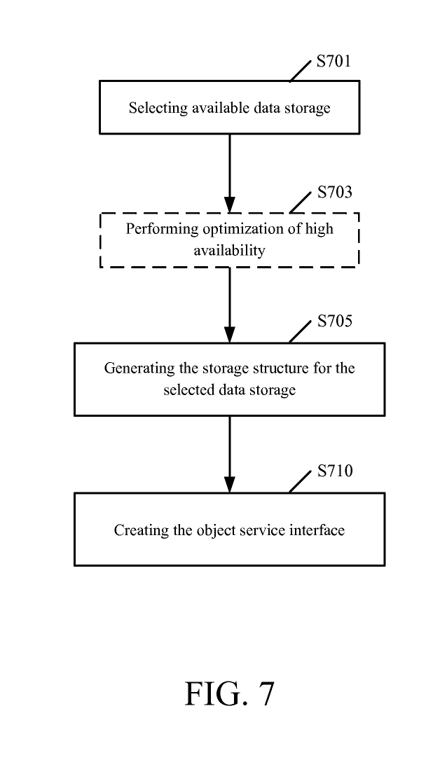

Returning to FIG. 4, at step S420, at least one data storage and at least one data service for the complex object are generated in the cloud environment, based on the desired at least one data storage and at least one data service determined in step S410. FIG. 7 shows the schematic flowchart of the step S420.

In one embodiment, as shown in FIG. 7, firstly, at step S701, the available data storage is selected in the cloud environment based on the determined at least one desired data storage. Generally, all the supported data storages and data services have been registered in the cloud environment, and a catalog for the data storages and data services has been established. Thus, the available data storages corresponding to the desired at least one data storage may be selected according to the catalog. For example, if the desired data storages are the relational database, non-relational database, object storage system, index database system, the available relational database, non-relational database, object storage system, index database system are selected in the cloud environment as the data storages of the complex object.

Optionally, after the available data storages have been selected, at step S703, an optimization of high availability can be performed on at least one of the selected available data storages. High availability of the data storages can be guaranteed through the optimization of high availability. In one embodiment, a plurality of backup data storages may be established for the data storages, thereby improving the high availability of the data storages. This embodiment is especially suitable for an object storage system. In another embodiment, for a MySQL database, the high availability may be provided by using MySQL clustering technology.

Next, at step S705, the storage structure of each of the selected available data storages is generated. For example, for a SQL database, its storage structure may comprise database connection, table name. For a NoSQL database, its storage structure may comprise connection information and connection name. For those skilled in the art, the generation of storage structures of various types of data storages in the cloud environment is well known, and the related description will be omitted here.

Then, at step S710, the object service interface corresponding to the desired at least one data service is created. As stated above, the object service interface may comprise an interface for attributes, an interface for methods and an interface for constraints. The generated data storage may be accessed via the created object service interfaces to perform operations on the stored data.

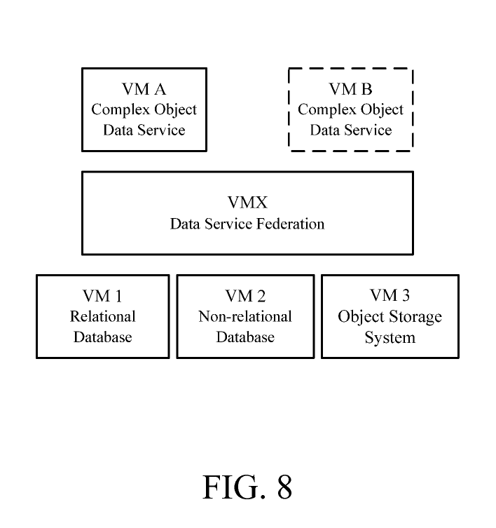

The generated data storages and data services may be presented in the form of virtual machines, so as to generate a VM structure with data storages and data services for the complex object. FIG. 8 shows a diagram of an example of such a VM structure. In the example, as shown in FIG. 8, the virtual machines VM1, VM2, VM3 represent three kinds of data storages, the virtual machine VMX represents the data service, and VM A and VM B represent the data services provisioned to a certain type of complex object respectively. For different complex objects, the data services may be provisioned in the form of data service federation.

Those skilled in the art will appreciate that FIG. 8 is merely the schematic diagram of the example of the VM structure, and other VM structures may also be employed. For example, the data services on VM A and VM B may reside on the same virtual machine.

It can be seen from the above description that the method for managing a complex object of the present embodiment has extended the object model of the complex object for System of Engagement applications, and is capable of simply and flexibly generating the data storages and data services for the complex object.

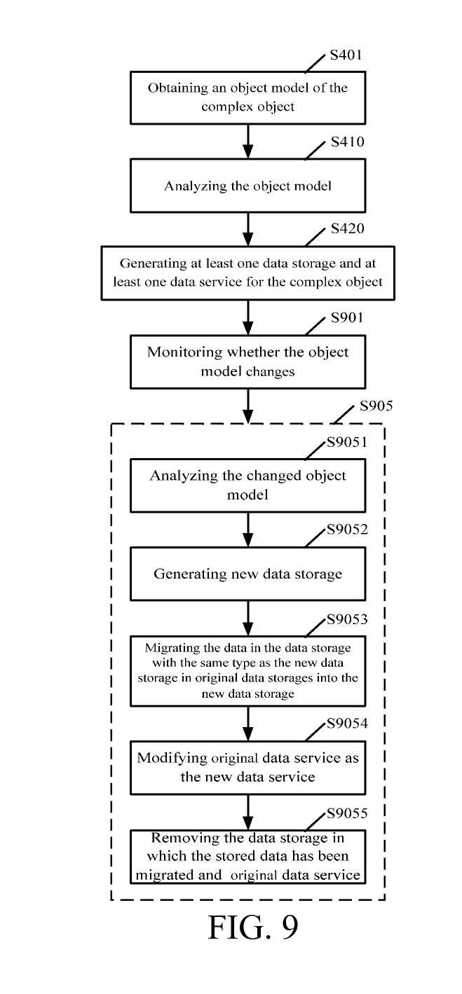

FIG. 9 shows a schematic flowchart of the method for managing a complex object in a cloud environment according to another embodiment of the present invention. The present embodiment will be described in detail below in conjunction with accompany drawings, wherein for the same parts as those of the previous embodiment, the same reference numbers are used and the description will be properly omitted.

In the method of the embodiment shown in FIG. 9, an operation of updating the data storages and data services when the object model changes is added to the method of the embodiment shown in FIG. 4.

As shown in FIG. 9, at step S901, it is monitored whether the object model of the complex object changes. Here, it is assumed that the change of the object model is compatible with the original object model. In the present embodiment, the change of the object model may comprise: add new information (for example, the information describing new attribute, the information describing new constraint, etc.), delete at least one piece of current information (for example, delete the information describing a certain attribute) or modify at least one piece of current information (for example, modify the data type of a certain attribute, etc.).

Next, at step S905, the original data storages and original data services for the complex object are updated in response to the change of the object model. In one embodiment, firstly at step S9051, the changed object model is analyzed to determine the desired data storage mapped with the change of the object model and new data services. This analyzing step is same as the analyzing step S410 described above, and its description will be omitted here. Next, at step S9052, new data storage is generated based on the desired data storage determined at step S9051. This generating step is same as the step S420 described above, and its description will be omitted here. Next, at step S9053, the data in the data storage with the same type as the generated new data storage in the original data storages is migrated into the new data storage. For example, if the change of the object model results in addition of the new attribute (data type of which is Int, for example), new data storage will be generated for this change, for example, a new relational database, and then the data in the relational database in the original data storages will be migrated to the new relational database. Next, at step S9054, the original data service is modified as the new data service, that is, the original data service is replaced with the new data service, and at step S9055, the data storage in which the stored data has been migrated in the original data storages and the original data services are removed.

It can be seen from the above description that the method for managing a complex object of the present embodiment is further capable of automatically updating the corresponding data storages and data services when the object model of the complex object changes without modifying the program of the System of Engagement application.

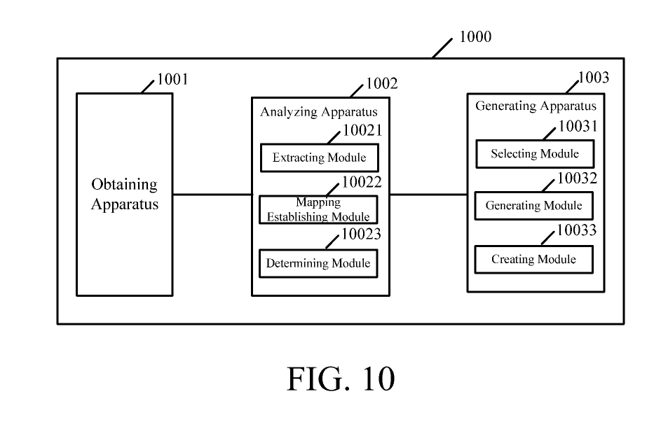

Under the same inventive conception, FIG. 10 shows a schematic block diagram of the system 1000 for managing a complex object in a cloud environment according to an embodiment of the present invention. The present embodiment will be described in detail below in conjunction with accompany drawings, wherein the description of the same parts as those of the previous embodiments will be properly omitted.

As shown in FIG. 10, the system 1000 of the present embodiment comprises: an obtaining hardware apparatus 1001 configured to obtain an object model of the complex object of the System Of Engagement (SOE) application, wherein the object model comprises at least information describing a constraint, an attribute and a method of the complex object; an analyzing hardware apparatus 1002 configured to analyze the obtained object model to determine at least one desired data storage mapped with the object model and at least one desired data service representing an object service interface for accessing the complex object; and a generating hardware apparatus 1003 configured to generate at least one data storage and at least one data service for the complex object in the cloud environment based on the desired at least one data storage and at least one data service.

Optionally, the object model of the complex object may further comprise information describing at least one of a relationship and a condition-action of the complex object.

In the present embodiment, the constraint of the complex object may comprise at least one of the following: search-able of the attribute, follow-able of the complex object, tag-able of the complex object, comment-able of the complex object, and locatable of the complex object. The constraints of the complex object have been described in detail above and their description will be omitted here.

In the system 1000 of the present embodiment, after the obtaining hardware apparatus 1001 has obtained the object model of the complex object, the analyzing hardware apparatus 1002 analyzes the obtained object model.

In one embodiment, in the analyzing hardware apparatus 1002, an extracting module 10021 extracts metadata from the object model, next, a mapping establishing module 10022 establishes a mapping from the attribute in the object model to the corresponding data storage based on the extracted metadata, and a determining module 10023 determines at least one object service interface based on the information in the object model.

In one embodiment, the mapping establishing module 10022 may comprise: a determining unit configured to determine that the attribute is any one of structural data, semi-structural data, non-structural data, spatial data and text data to be retrieved based on the extracted metadata; and a mapping unit configured to map the attribute to a relational database in response to determining the attribute as the structural data, to map the attribute to a non-relational database in response to determining the attribute as the semi-structural data, to map the attribute to an object storage system in response to determining the attribute as the non-structural data, to map the attribute to a spatial database in response to determining the attribute as the spatial data, and to map the attribute to an index database system in response to determining the attribute as the text data to be retrieved.

In one embodiment, the determining module 10023 may be configured to determine, in response to the information describing the attribute of the complex object, an interface for adding, deleting, modifying and querying the attribute, to determine, in response to the information describing the method of the complex object, an interface for exposing a public method, and to determine, in response to the information describing the constraint of the complex object, an interface for adding, obtaining and deleting the constraint.

Then, the generating hardware apparatus 1003 generates at least one data storage and at least one data service for the complex object based on the desired at least one data storage and at least one data service obtained in the analyzing hardware apparatus 1002.

In one embodiment, in the generating hardware apparatus 1003, a selecting module 10031 selects the available data storage corresponding to the desired at least one data storage in the cloud environment, and a generating module 10032 generates the respective storage structures for the selected available data storages, and then a creating module 10033 creates the corresponding object service interface based on the desired at least one data service.

Optionally, the generating means 1003 may further comprise an optimizing module configured to perform optimization of high availability on at least one of the selected available data storages.

It should be noted that the system 1000 of the present embodiment is operable to implement the method for managing a complex object in a cloud environment shown in FIGS. 4, 6 and 7.

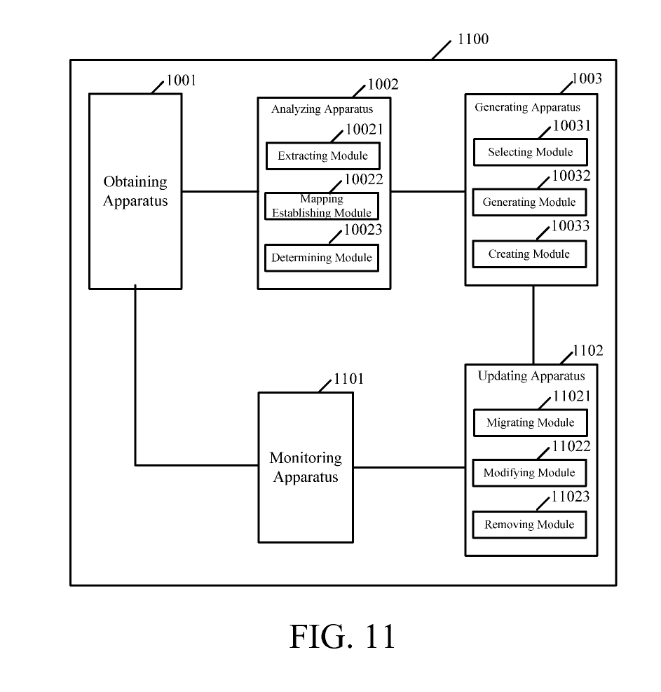

FIG. 11 shows a schematic block diagram of the system 1100 for managing a complex object in a cloud environment according to another embodiment of the present invention. The present embodiment will be described in detail below in conjunction with accompany drawings, wherein for the same parts as those of the previous embodiments, the same reference numbers are used and their description will be properly omitted.

In the system 1100 shown in FIG. 11, a monitoring hardware apparatus means 1101 and an updating hardware apparatus 1102 are added to the system 1000 shown in FIG. 10. The monitoring hardware apparatus 1101 is configured to monitor whether the object model changes. The updating hardware apparatus 1102 is configured to update the at least one data storage and the at least one data service for the complex object in response to the change of the object model.

In one embodiment, the monitoring hardware apparatus 1101 is configured to monitor whether new information has been added to the object model, or at least one piece of original information has been deleted from the object model, or at least one piece of original information has been modified in the object model.

In an embodiment, when the object model changes, the analyzing hardware apparatus 1002 further analyzes the changed object model to determine the desired data storage mapped with the change and at least one new data service, then, the generating hardware apparatus 1003 further generates the new data storage based on the desired data storage. Next, a migrating module 11021 of the updating hardware apparatus 1102 migrates the data in the data storage with the same type as the new data storages in the original data storages into the new data storage, and a modifying module 11022 modifies the original data service as the new data service. Then a removing module 11023 removes the data storage in which the stored data has been migrated in the original data storages and the original data services.

It should be noted that the system 1100 of the present embodiment is operable to implement the method for managing a complex object in a cloud environment shown in FIG. 9.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for managing a complex object in a cloud environment, the method comprising:
obtaining, by one or more processors, an object model of the complex object, the object model comprising information describing a constraint, an attribute and a method of the complex object;
analyzing, by one or more processors, the object model to determine at least one desired data storage mapped with the object model and at least one desired data service representing an object service interface for accessing the complex object; and
generating, by one or more processors, at least one data storage and at least one data service for the complex object in the cloud environment, based on the desired at least one data storage and at least one data service.

2. The method according to claim 1, wherein the constraint comprises at least one of:
being search-able of the attribute,
being follow-able of the complex object,
being tag-able of the complex object,
being comment-able of the complex object, and
being locatable of the complex object.

3. The method according to claim 1, wherein the object model further comprises information describing at least one of a relationship and a conditions-action of the complex object.

4. The method according to claim 1, wherein the analyzing of the object model to determine at least one desired data storage mapped with the object model and at least one desired data service representing an object service interface for accessing the complex object comprises:
extracting, by one or more processors, metadata from the object model;
establishing, by one or more processors, a mapping from the attribute to the corresponding data storage based on the extracted metadata; and
determining, by one or more processors, at least one object service interface based on the information.

5. The method according to claim 4, wherein the establishing of a mapping from the attribute to the corresponding data storage based on the extracted metadata comprises:
determining, by one or more processors, that the attribute is any one of structural data, semi-structural data, non-structural data, spatial data and text data to be retrieved based on the extracted metadata;
mapping, by one or more processors, the attribute to a relational database in response to determining that the attribute is the structural data;
mapping, by one or more processors, the attribute to a non-relational database in response to determining that the attribute is the semi-structural data;
mapping, by one or more processors, the attribute to an object storage system in response to determining that the attribute is the non-structure data;
mapping, by one or more processors, the attribute to a spatial database in response to determining that the attribute is the spatial data; and
mapping, by one or more processors, the attribute to an index database system in response to determining that the attribute is the text data to be retrieved.

6. The method according to claim 4, wherein the determining of at least one object service interface based on the information comprises:
determining, by one or more processors and in response to the information describing the attribute of the complex object, an interface for adding, deleting, modifying and querying the attribute;
determining, by one or more processors and in response to the information describing the method of the complex object, an interface for exposing a public method; and
determining, by one or more processors and in response to the information describing the constraint of the complex object, an interface for adding, obtaining and deleting the constraint.

7. The method according to claim 1, wherein the generating of at least one data storage and at least one data service for the complex object in the cloud environment based on the desired at least one data storage and at least one data service comprises:
selecting, by one or more processors, the available data storage corresponding to the desired at least one data storage in the cloud environment;
generating, by one or more processors, a storage structure for the selected available data storage; and
creating, by one or more processors, the corresponding object service interface based on the desired at least one data service.

8. The method according to claim 7, wherein the generating of at least one data storage and at least one data service for the complex object in the cloud environment based on the desired at least one data storage and at least one data service further comprises:
performing, by one or more processors, optimization of high availability on at least one of the selected available data storage.

9. The method according to claim 1, further comprising:
monitoring, by one or more processors, whether the object model changes; and
updating, by one or more processors, the at least one data storage and the at least one data service for the complex object in response to the change of the object model.

10. The method according to claim 9, wherein monitoring whether the object model changes comprises:
monitoring, by one or more processors, whether new information has been added to the object model, or at least one piece of the information has been deleted from the object model, or at least one piece of the information has been modified in the object model.

11. The method according to claim 9, wherein the updating of the at least one data storage and the at least one data service for the complex object in response to the change of the object model comprises:
analyzing, by one or more processors, the changed object model to determine the desired data storage mapped with the change and at least one new data service;
generating, by one or more processors, the new data storage based on the desired data storage;
migrating, by one or more processors, the data in the data storage with the same type as the new data storage in the at least one data storage into the new data storage;
modifying, by one or more processors, the at least one data service as the at least one new data service; and
removing, by one or more processors, the data storage in which the stored data has been migrated and the at least one data service.

12. A system for managing a complex object in a cloud environment, comprising:
an obtaining hardware apparatus configured to obtain an object model of the complex object, the object model comprising at least information describing a constraint, an attribute and a method of the complex object;
an analyzing hardware apparatus configured to analyze the object model to determine at least one desired data storage mapped with the object model and at least one desired data service representing an object service interface for accessing the complex object; and
a generating hardware apparatus configured to generate at least one data storage and at least one data service for the complex object in the cloud environment based on the desired at least one data storage and at least one data service.

13. The system according to claim 12, wherein the constraint comprises at least one of:
being search-able of the attribute,
being follow-able of the complex object,
being tag-able of the complex object,
being comment-able of the complex object, and
being locatable of the complex object.

14. The system according to claim 12, wherein the object model further comprises information describing at least one of a relationship and a conditions-action of the complex object.

15. The system according to claim 12, wherein the analyzing hardware apparatus comprises:
an extracting module configured to extract metadata from the object model;
a mapping establishing module configured to establish a mapping from the attribute to the corresponding data storage based on the extracted metadata; and
a determining module configured to determine at least one object service interface based on the information.

16. The system according to claim 15, wherein the mapping establishing module comprises:
a determining hardware unit configured to determine that the attribute is any one of structural data, semi-structural data, non-structural data, spatial data and text data to be retrieved based on the extracted metadata;
a mapping hardware unit configured to map the attribute to a relational database in response to determining that the attribute is the structural data, to map the attribute to a non-relational database in response to determining that the attribute is the semi-structural data, to map the attribute to an object storage system in response to determining that the attribute is the non-structural data, to map the attribute to a spatial database in response to determining that the attribute is the spatial data, and to map the attribute to an index database system in response to determining that the attribute is the text data to be retrieved.

17. The system according to claim 15, wherein the determining module is configured to determine, in response to the information describing the attribute of the complex object, an interface for adding, deleting, modifying and querying the attribute, to determine, in response to the information describing the method of the complex object, an interface for exposing a public method, and to determine, in response to the information describing the constraint of the complex object, an interface for adding, obtaining and deleting the constraint.

18. The system according to claim 12, wherein the generating hardware apparatus comprises:
a selecting module configured to select the available data storage corresponding to the desired at least one data storage in the cloud environment;
a generating module configured to generate the storage structures for the selected available data storage; and
a creating module configured to create the corresponding object service interface based on the desired at least one data service.

19. The system according to claim 18, wherein the generating hardware apparatus further comprises:
an optimizing module configured to perform optimization of high availability on at least one of the selected available data storage.

20. A computer program product for managing a complex object in a cloud environment, the computer program product comprising a computer readable storage medium having program code embodied therewith, the program code readable and executable by a processor to perform a method comprising:
obtaining an object model of the complex object, the object model comprising information describing a constraint, an attribute and a method of the complex object;
analyzing the object model to determine at least one desired data storage mapped with the object model and at least one desired data service representing an object service interface for accessing the complex object; and
generating at least one data storage and at least one data service for the complex object in the cloud environment, based on the desired at least one data storage and at least one data service.
